(19) United States
(12) Patent Application Publication
(10) Pub. No.: US 2020/0369048 A1
(43) Pub. Date: Nov. 26, 2020

(54) SUBSTRATE COMPACTNESS DETECTION

(71) Applicant: HEWLETT-PACKARD DEVELOPMENT COMPANY, L.P., Spring, TX (US)

(72) Inventors: Antonio Gracia Verdugo, Sant Cugat del Valles (ES); Aleix Fort Filgueira, Sant Cugat del Valles (ES); Carles Flotats Villagrasa, Sant Cugat del Valles (ES)

(21) Appl. No.: 16/493,007

(22) PCT Filed: Jan. 30, 2018
(86) PCT No.: PCT/US2018/016037

§ 371 Date: Sep. 11, 2019

(51) Int. Cl. B41J 11/00; B65H 23/18

(52) U.S. Cl. CPC B41J 11/0095; B65H 23/18; B65H 2515/12; B65H 2513/11; B65H 2511/13

(57) ABSTRACT

It is disclosed a substrate compactness detection method for a printer wherein the printer comprises a roller to receive a substrate roll and a media advance mechanism to receive a substrate from the substrate roll, the method comprising: determining a substrate thickness; advancing the substrate for a length; measuring an angular displacement of the roller caused by the advancing of the substrate; determining the substrate roll radius by using the length and the angular displacement; and calculating a compactness parameter in view of the substrate roll radius and the substrate thickness.

### BACKGROUND

Printers are, in general terms, devices that modify the composition of a substrate as to incorporate an image. In particular, printing fluid-based printers are fluid ejection devices that transfer a printing fluid such as an ink from a storage to form an image on the substrate. In all printing technologies substrate management is a relevant aspect as, depending on the type and format of the substrate to use, printing and handling parameters may be set on the printer to ensure that the printed substrate is printed correctly and managed appropriately to avoid damages on the substrate, e.g., wrinkles.

### BRIEF DESCRIPTION OF THE DRAWINGS

Examples will now be described, by way of non-limiting example, with reference to the accompanying drawings, in which:

FIG. 1 shows a schematic view of a printing system according to an example.

FIG. 2A shows a flow diagram of a method for determining roll compactness according to an example.

FIG. 2B shows a flow diagram of a method for determining a substrate thickness, according to an example.

FIG. 3 shows a schematic view of a roll-to-roll printing system according to an example.

FIG. 4 shows a flow diagram for media thickness and roll compactness detection method according to an example.

### DETAILED DESCRIPTION

Printing systems may be used to print different types of substrates. For each particular type of substrate, the printer parameters may be changed to provide for an adequate quality level, In printing systems in which the substrate is input in a roll format and the output is also in a roll format (commonly known as roll-to-roll printing systems), the compactness of the substrate on the output roll is a relevant parameter to monitor since a lack of compactness is often linked to wrinkles and low transferring success which eventually causes repeated prints and waste.

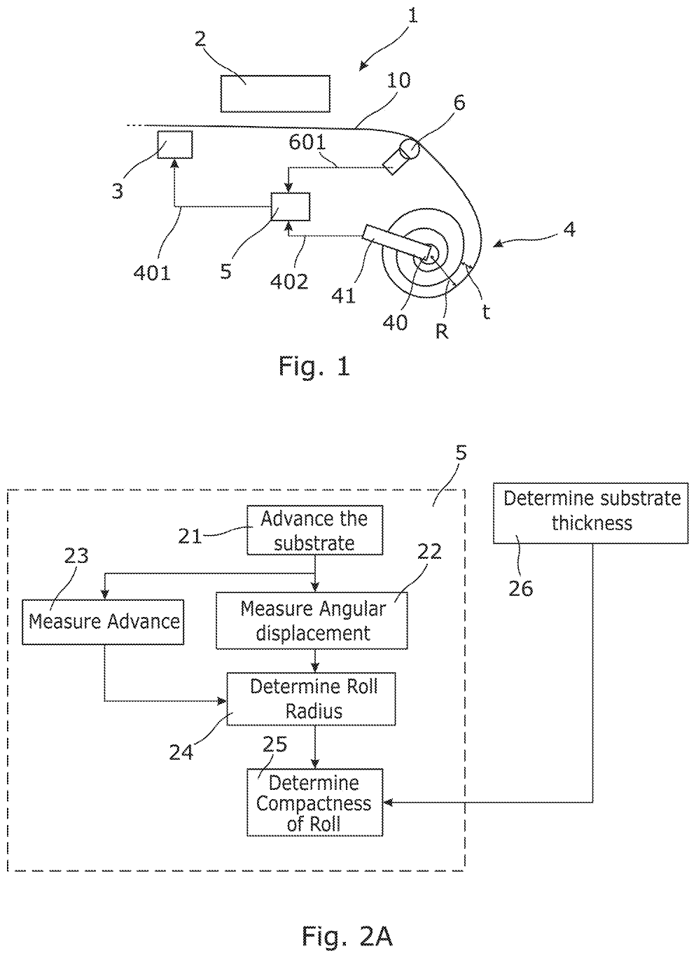

FIG. 1 shows an example of a printing system 1 comprising a media advance mechanism 3 for feeding a substrate 10 to a printer 2 of the printing system 1 wherein, after processing by the printer 2, a printed substrate is obtained and is received by an output roller 40 thereby forming an output roll 4.

A media advance mechanism 3 is provided to manage the feeding of the substrate 10 from its loading wherein it is provided, for example, in the form of a substrate input roll, feeding it to the printer 2, and advancing the substrate from the printer 2 towards a store, e.g., in case of a roll to roll printing system, to an output roller 40. An example of a media advance mechanism 3 comprises a feeding roller wherein a substrate roll is provided, the feeding roller may comprise a motor which speed is controllable and an encoder to provide the system with the angular position and/or velocity of the feeding roller. In an example, the feeding roller may be the output roller 40 which may comprise a motor to pull the substrate from an input. Other examples of media advance mechanisms may be a vacuum pump with a conveyor belt, adhesive media advance systems, and/or any other assembly of mechanical parts to move the substrate through the printing system 1.

Further, the printing system 1 may comprise a media advance sensor 6 to determine the amount of substrate 10 that is being advanced by the media advance mechanism 3. The media advance sensor 6 may be, e.g., an encoder and the media advance sensor 6 may be external to the input and output rollers as to have an independent measurement which is not affected by the thicknesses of the input and/or output substrate rolls.

In an example, a controller 5 is provided in the printing system 1 wherein the controller 5 is to determine a compactness parameter of a roll, for example, a compactness parameter of an output roll 4.

The controller may receive a media detection signal 601 from the media advance sensor 6 indicating a length of substrate that passes over the media advance sensor 6, an output angular position signal 402 which indicates the angular position of the output roller 40, and may issue a media actuation signal 401 to the media advance mechanism 3 that controls the feeding of substrate to the printer 2 and/or the output roller 40.

A controller is considered, within the context of this disclosure, as any device comprising a processor and a memory being the processor configured to execute a set of instructions in view of an input (that may be stored in the memory) and issue an actuation signal.

An example of a compactness parameter may be an interlayer distance (t) that, in the case of a substrate in a roll format, can be defined as the radial distance between two successive layers of substrate.

The controller 5 may be to determine the interlayer distance (t) by calculating the radius (R) of the output roll 4 and monitoring the change on the radius when a determined length of substrate 10 is fed to the output roll.

For example, if a length (d) of substrate is fed to an output roller 40 (or is pulled by the output roller 40), the radius of the output roll 4 can be defined as:

$$R = \frac{d}{α [ rad ]} ;$$

wherein α may be the angular position of the output roller 40 which is measured and communicated to the controller 5 as the output angular position signal 402, and d may be the length of substrate fed or retrieved by the output roller 40 and is measured by the media advance sensor 6 as the media detection signal 601. The controller 5 may then be able to determine a radius change, i.e., the interlayer distance (t) caused by the length of substrate (d).

Additionally, the controller 5 may have be provided with information regarding a thickness of the substrate 10 which may help determine if the interlayer distance (t) is appropriate for such a thickness. The thickness may be provided to the controller by the user, it may be retrievable from a table within a memory, may be measured with a specific sensor or may be also be determined by the controller 5.

In an example, if the interlayer distance (t) is over 1.1 times the thickness of the substrate 10, the controller may issue an alert signal.

In a further example, if the interlayer distance (t) changes in a determined period in a magnitude over a determined threshold, the controller may issue an alert signal indicating that a lack of compactness has occurred. Therefore, the controller may be to store several interlayer distance (t) values gathered at different times and may be able to determine a magnitude of the change of the interlayer distance (t) and compare it to a threshold value.

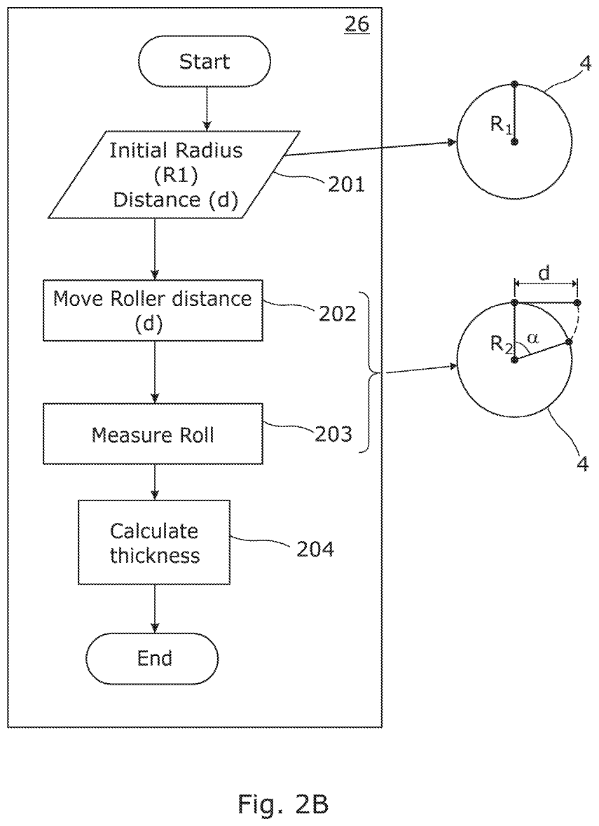

FIG. 2A shows an example of a flow diagram for determining a compactness parameter of a substrate roll. In the example of FIG. 2, the controller 5 is to issue a media actuation signal as to advance the substrate 21 for a determined length.

Then, a media advance sensor is provided to measure the advance 23 as to have a measurement of the determined length that has been advanced independent of the roller 40. Also, the angular displacement is measured 22 for the roller that receives the substrate roll, that is, the angular displacement caused by the feeding of the determined length of substrate to the substrate roll 4.

Having determined the measurements of the advance and the angular displacement, the roll radius may be determined 24. The controller 5 may then further determine the compactness of the roll 25, in particular, determining if the current radius (or the change in the radius of the roller in view of the feeding of a determined length of substrate) corresponds to an appropriate level of compactness. To determine if the compactness level is appropriate, the controller may calculate the distance between the layers of substrate within the substrate roll, i.e. the interlayer distance, and determine if the interlayer distance exceeds a threshold value, e.g., a percentage over the substrate thickness.

In an example, for determining the thickness of the substrate 26 the controller 5 may access a look up table wherein thickness parameters are stored for a set of substrates. In this manner, upon determination of a substrate type (e.g., by user input), the controller 5 may determine the thickness of the substrate.

In a further example, an encoder associated to the roller may be used for determining the thickness of the substrate as will be explained with reference to FIG. 2B.

FIG. 2B shows a flow diagram wherein an encoder and a sensor may be used to determine the thickness 26 of a substrate roll. Initially, an initial radius (R₁) of the substrate roll 2 is established and a distance (d) is selected 201, the first radius (R₁) may be a previously known radius, e.g., a previously measured radius and the distance (d) may be a pre-determined length of substrate to perform the thickness calculation.

Then, a length (d) of substrate is withdrawn or fed to the substrate roll thereby moving the roller 202, the length may be measured by a media advance sensor remote to the roller.

Subsequently, the angular position (α) of the roller 4 is measured 203, e.g., by means of an encoder associated to the roller. The radius of the roller has now changed to a new radius (R₂), the radius can be easily calculated given that the angular position (α) was measured and the arc for the angular position (α) corresponds to the distance (d) of substrate withdrawn or fed to the substrate roll 4. Then, the new radius (R₂) may be estimated by the equation:

$${R}_{2} = \frac{d}{α [ rad ]}$$

Finally, the thickness is estimated 204 in view of the radius. In particular the thickness of the substrate is substantially the difference between the initial radius (R₁) and the new radius (R₂) in good compactness conditions. In an example, this thickness is determined in a substrate roll before it is printed (input roll) and may be used as a reference for further measurements, e.g., in a substrate roll after the substrate has been printed (output roll).

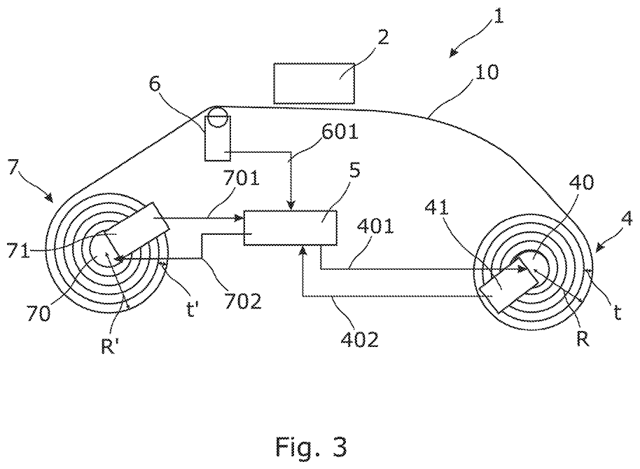

FIG. 3 shows an example of a compactness detection method for use in printing system 1, in particular, a roll-to-roll printing system.

The system of FIG. 3 comprises an input roll 7 carrying a substrate 10 before it is printed in an input roller 70 provided with an input roller encoder 71. The substrate 10 from the input roll is provided to the printer 2 and subsequently stored after print in an output roll 4 which is provided in an output roller that, likewise, comprises an output roller encoder 41.

Further the printing system 1 comprises a media advance sensor 6 which is independent from the input roller 70 and the output roller 40. The media advance sensor 6 is to detect the length of media that is fed to the printer 2. Alternatively, the media advance sensor 6 may be provided between the printer and the output roller thereby determining the length of substrate that is fed to the output roll 4. In an example, the media advance sensor 6 is an encoder.

The output roller 40 comprises a motor and can, therefore, act as a media advance mechanism by pulling substrate from the input roll 7 and/or the printer 2.

The printing system 1 further comprises a controller 5 which is associated with the input roll 7 as to receive from the input encoder 71 an input roller angular position 701 and send an input roller actuation signal 702 to a motor associated to the input roller 70 as to provide substrate 10 to the printer 2. The controller may also be associated to the media advance sensor 6 as to receive a media detection signal 601 which corresponds to the amount of substrate that is fed to a part of the system 1 such as the printer 2 or the output roll 4. Furthermore, the controller 5 may be associated to the output roll 4 as to receive from the output roll 4 an output angular position signal 402 an to issue a media actuation signal 401 as to control the motor associated to the output roller 40 as to pull substrate into the output roll 4.

In an example, to determine an appropriate compactness of an output roll 4, the controller 5 may be configured issue a media actuation signal 401 to the motor of the output roller 40, for example, as to pull towards the output roll 4 a determined length (d) of substrate 10. The media advance sensor 6 measures the length of the substrate 10 fed to the output roll 4, the output roller encoder 41 may determine the angular displacement (α) of the output roller 40, and the angular displacement (α′) of the input roller 70 caused by such media advance may be determined by the input roller encoder 71.

Then, the controller may determine a compactness parameter, such as the interlayer distance (t, t′) of the output roll (4) and/or the input roller (7). In an example, the interlayer distance (t) for the output roll (4) may be determined considering that in a circumference the angular position is determined by the arc and the radius by the equation:

d=R·α; (1)

In the system of FIG. 3, the length (d) of substrate that is advanced corresponds to the arc and can be measured with the media advance sensor (6), the angular displacement (a) caused by such advance on the output roller (40) can be determined by the output encoder (41), and R is the radius of the output roll.

If the increment is infinitesimal in length then:

δd=r(α)·δα; (2)

Further, every time there is a full turn in the roll, the radius is incremented by the interlayer distance (t) and the angle is incremented 2Π times. Proportionally, if the angle is incremented by a δα, then the radius is incremented in:

$$δ R = \frac{t \cdot δα}{2 π} ; \qquad ( 3 )$$

which in the limit of δα tends to zero, then:

$$\frac{dR}{d α} = \frac{t}{2 π} ; \qquad ( 4 )$$

which has the solution of:

$$R ( α ) = \frac{t}{2 π} α + R ( 0 ) ; \qquad ( 5 )$$

using (2) in (5) we have:

$$\frac{δ d}{δα} = \frac{t}{2 π} α + R ( 0 ) ; \qquad ( 6 )$$

In the limit and integrating with s=0 when α=0, then:

$$d = t \frac{{α}^{2}}{4 π} + R ( 0 ) α ; \qquad ( 7 )$$

Since, the advanced length (d) and the angular displacement (α) are known, then, the difference between two different lengths (d₁, d₂) advanced by the media advance mechanism can be calculated as:

$$\begin{matrix}\frac{( {d}_{1} - t \frac{{α}_{1}^{2}}{4 π} )}{{α}_{1}} = r ( 0 ) ; & ( 8 ) \\ \frac{( {d}_{2} - t \frac{{α}_{2}^{2}}{4 π} )}{{α}_{2}} = r ( 0 ) ; & \end{matrix}$$

obtaining:

$$\frac{( {d}_{1} - t \frac{{α}_{1}^{2}}{4 π} )}{{α}_{1}} = \frac{( {d}_{2} - t \frac{{α}_{2}^{2}}{4 π} )}{{α}_{2}} ; \qquad ( 9 )$$

Therefore, in an example, the interlayer distance (t) of the output roll (4) can be determined by comparing displacement angles (α₁, α₂) and lengths (d₁, d₂) by using the equation:

$$t = \frac{4 π ( {d}_{2} {α}_{1} - {d}_{1} {α}_{2} )}{{α}_{2}^{2} {α}_{1} - {α}_{1}^{2} {α}_{2}} ; \qquad ( 10 )$$

This determination of the interlayer distance may also be performed, for example, in the input roll (7) at the beginning of the printing process to know the interlayer distance (t′) of the substrate before it is printed and use the interlayer distance (t′) of the input roll (7) (or define a range in view of such interlayer distance) as a compactness parameter threshold. Then, during printing, determine the interlayer distance (t) of the output roll (4) an establish whether the compactness is still in an acceptable range. In an example, the compactness parameter threshold is 1.1 times the input roll compactness parameter (t′). In a further example, the compactness parameter threshold is 1.05 times the input roll compactness parameter (t′).

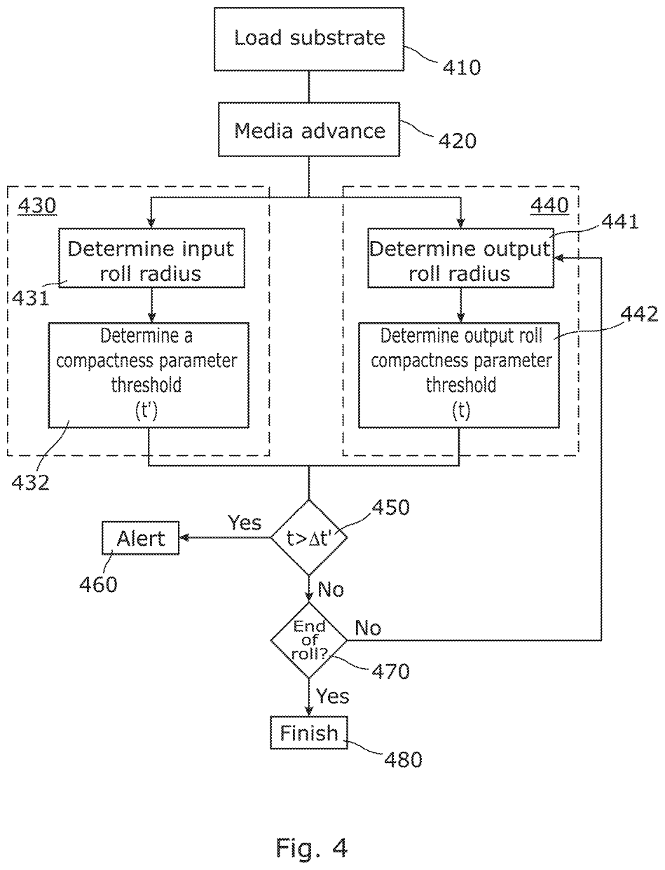

FIG. 4 is an example of a flow diagram for a method to determine an appropriate output roll compactness according to an example.

It is disclosed a method wherein a substrate is loaded 410, for example, by loading an input roll in an input roller 70 and arranging it to pass through a print zone within a printer 2 and after printing storing it as an output roll 4 loaded in an output roller 40.

Then, the substrate is advanced 420 for a determined length, such length may be, e.g., a predetermined length (d) configured on the controller 5 and may be measured by a media advance sensor 6 independent from the input and output rollers.

Then, calculations for the input roll 430 are performed. Considering the length and the angular displacement of the input roller 40, the controller 5 may determine the input roll radius 431 and, also, may determine a compactness parameter threshold 432 which may be, e.g., a constant (Δ) multiplied by the interlayer distance (t′) for the input roll 4. The constant (Δ) may be a value between 1 and 1.2 and, in an example, a value between 1.05 and 1.1.

In an example, the calculations for the input roll 430 may not be performed and the compactness parameter threshold may be a predetermined value stored in a memory accessible by the controller 5.

Also, calculations for the output roll 440 are performed. These calculations comprise determining the output roll radius 441 in view of the length (d) and the angular displacement of the output roller 40 and, also, determining an output roll compactness parameter, e.g., the output roll interlayer distance (t).

Then, once the compactness parameter (t) for the output roll 4 and the compactness parameter threshold has been established, a conditional operation 450 is performed to determine if the compactness parameter (t) of the output roll is below the defined threshold value (Δt′). If the condition is fulfilled then an alert is issued 460 to inform the user that the output roll may not be compact enough to ensure an appropriate storage of the substrate within the output roll 4. If it is not, then a further conditional operation 470 is performed to determine if the roll is completely printed. If the roll is not completely printed then the monitoring is continued by continuing the calculations on the output roll 440 and, if the roll is finished, then the monitoring is ended 480.

In particular, it is disclosed a substrate compactness detection method for a printer wherein the printer comprises a roller (for example, an output roller) to receive a substrate roll and a media advance mechanism to receive a substrate from the substrate roll, the method comprising:
determining a substrate thickness;
advancing the substrate for a length;
measuring an angular displacement of the roller caused by the advancing of the substrate;
determining the substrate roll radius by using the length and the angular displacement; and
   calculating a compactness parameter in view of the substrate roll radius and the substrate thickness.

In an example, the determining of the substrate thickness comprises advancing the substrate for a second length, measuring a second angular displacement, determining the thickness of the substrate in view of the second angular displacement and the second length.

In an example, the length and the second length may have the same magnitude which helps in reducing the computational cost of the method.

In an example, the advancing the substrate for a length comprises measuring the length by a media advance sensor remote to the roller. The media advance sensor may also be an encoder and, in an example, it is independent from the roller.

In an example, the compactness parameter is compared to a compactness range and an alert signal is issued if the compactness is outside the compactness range. The range may be defined, e.g., depending on the thickness of the substrate or depending on a compactness parameter of another substrate roll, such as a substrate roll before it is printed.

In another example, the printer comprises an input roller and an output roller and, in this case, the method comprises:
calculating an input roller compactness parameter and an output roller compactness parameter for the input and the output roller respectively;
determining the compactness range based on the compactness parameter of the input roller;
comparing the output roller compactness parameter with the compactness range;
   issuing the alert signal if the output roller compactness is outside the compactness range.

Furthermore, it is disclosed a substrate compactness detection method for a printer wherein the printer comprises a roller to receive a substrate roll and a media advance mechanism to receive a substrate from the substrate roll, the method comprising:
advancing the substrate for a length;
measuring an angular displacement of the roller;
advancing the substrate for a second length;
measuring a second angular displacement; and
determining a substrate compactness parameter based on the length, the second length, the angular displacement and the second angular displacement.

In an example, the roller is an output roller.

In a further example, the method further comprises:
determining a substrate compactness parameter for the output roller
determining a second substrate compactness parameter of an input roller wherein the input roller and the output roller are connected through the substrate,
comparing the output roller compactness parameter with the input roller compactness parameter; and
issuing an alert signal if the comparison exceeds a compactness range.

In an example, the angular displacement of the roller is measured by an encoder connected or, at least, associated to the roller.

Further, the advancing the substrate for a length and a second length may comprise measuring the length and the second length by a media advance sensor remote to the roller. The media advance sensor may be, for example, a further encoder within the path of the substrate between the input roll and the output roll.

Also, it is disclosed a printing system that comprises:
a roller adapted to receive a substrate from a printer
an encoder associated to the roller;
a media advance mechanism adapted to advance the substrate;
a media advance sensor remote from the encoder adapted to measure a length of substrate advanced; and
a controller connected to the media advance mechanism, the encoder and the media advance sensor;
   wherein the controller is to activate media advance mechanism thereby advancing the media for a length determined by the media advance sensor, to receive from the encoder the angular displacement of the roller caused by the media advance and to determine a roller compactness parameter in view of the angular displacement, the length and a thickness of the substrate.

In an example, the thickness may be a value stored on a memory accessible or comprised by the controller.

In a further example, the system comprises an input roller and an output roller each comprising encoders for detecting their angular position and the controller is to determine a compactness parameter of the input roller and the output roller.

1. A substrate compactness detection method for a printer wherein the printer comprises a roller to receive a substrate roll and a media advance mechanism to receive a substrate from the substrate roll, the method comprising:
determining a substrate thickness;
advancing the substrate for a length;
measuring an angular displacement of the roller caused by the advancing of the substrate;
determining the substrate roll radius by using the length and the angular displacement; and
calculating a compactness parameter in view of the substrate roll radius and the substrate thickness.

2. The method of claim 1 wherein the determining of the substrate thickness comprises advancing the substrate for a second length, measuring a second angular displacement, determining the thickness of the substrate in view of the second angular displacement and the second length.

3. The method of claim 2, wherein the length and the second length have the same magnitude.

4. The method of claim 1, wherein the advancing the substrate for a length comprises measuring the length by a media advance sensor remote to the roller.

5. The method of claim 1, wherein the roller is an output roller of a printer.

6. The method of claim 1, wherein the compactness parameter is compared to a compactness range and an alert signal is issued if the compactness is outside the compactness range.

7. The method of claim 5, wherein the printer comprises an input roller and an output roller; the method comprising:
calculating an input roller compactness parameter and an output roller compactness parameter for the input and the output roller respectively;
determining the compactness range based on the compactness parameter of the input roller;
comparing the output roller compactness parameter with the compactness range;
issuing the alert signal if the output roller compactness is outside the compactness range.

8. A substrate compactness detection method for a printer wherein the printer comprises a roller to receive a substrate roll and a media advance mechanism to receive a substrate from the substrate roll, the method comprising:
advancing the substrate for a length;
measuring an angular displacement of the roller;
advancing the substrate for a second length;
measuring a second angular displacement; and
determining a substrate compactness parameter based on the length, the second length, the angular displacement and the second angular displacement.

9. The method of claim 8 wherein the roller is an output roller.

10. The method of claim 9, wherein the method further comprises:
determining a substrate compactness parameter for the output roller
determining a second substrate compactness parameter of an input roller wherein the input roller and the output roller are connected through the substrate,
comparing the output roller compactness parameter with the input roller compactness parameter; and
issuing an alert signal if the comparison exceeds a compactness range.

11. The method of claim 8 wherein the angular displacement of the roller is measured by an encoder connected to the roller.

12. The method of claim 8, wherein the advancing the substrate for a length and a second length comprises measuring the length and the second length by a media advance sensor remote to the roller.

13. A printing system that comprises:
a roller adapted to receive a substrate from a printer
an encoder associated to the roller;
a media advance mechanism adapted to advance the substrate;
a media advance sensor remote from the encoder adapted to measure a length of substrate advanced; and
a controller connected to the media advance mechanism, the encoder and the media advance sensor;
wherein the controller is to activate media advance mechanism thereby advancing the media for a length determined by the media advance sensor, to receive from the encoder the angular displacement of the roller caused by the media advance and to determine a roller compactness parameter in view of the angular displacement, the length and a thickness of the substrate.

14. The system of claim 13 wherein the thickness is stored on a memory accessible to the controller.

15. The system of claim 14 wherein the system comprises an input roller and an output roller each comprising encoders and the controller is to determine a com pactness parameter of the input roller and the output roller.
